(19) United States
(12) Patent Application Publication
(10) Pub. No.: US 2020/0102064 A1
(43) Pub. Date: Apr. 2, 2020

(54) FREE STREAMLINE AIRFOIL

(71) Applicant: Brown University, Providence, RI (US)

(72) Inventors: Matteo DI LUCA, Providence, RI (US); Kenneth BREUER, Newton, MA (US)

(21) Appl. No.: 16/586,338

(22) Filed: Sep. 27, 2019

Related U.S. Application Data
(60) Provisional application No. 62/739,731, filed on Oct. 1, 2018.
(60) Provisional application No. 62/741,743, filed on Oct. 5, 2018.
(60) Provisional application No. 62/852,835, filed on May 24, 2019.

(51) Int. Cl. B64C 3/14; B64C 23/00; B64C 23/02; B64C 9/04

(52) U.S. Cl. CPC B64C 3/14; B64C 23/005; B64C 23/02; B64C 9/04; B64C 2003/146; B64C 2230/12; B64C 2230/08; B64C 2230/04; B64C 23/00

(57) ABSTRACT

A free-streamline airfoil includes a front portion, the front portion including a leading edge geometry configured to force a sudden separation of the flow, and a contoured

### CROSS REFERENCE TO RELATED APPLICATIONS

This application claims benefit from U.S. Provisional Patent Application Ser. No. 62/739,731, filed Oct. 1, 2018, U.S. Provisional Patent Application Ser. No. 62/741,743, filed Oct. 5, 2018, and U.S. Provisional Patent Application Ser. No. 62/852,835, filed May 24, 2019, which are incorporated by reference in their entireties.

### STATEMENT REGARDING GOVERNMENT INTEREST

None.

### BACKGROUND OF THE INVENTION

The present invention relates generally to aerodynamics systems and apparatus for the production of lift or control forces for propellers, turning vanes, aircraft wings, missiles control surfaces, and more particularly, to a free streamline airfoil.

Airfoils operating in the low Reynolds number regime find application in wings and propellers of Miniature and Nano Air Vehicles (MAVs and NAVs), microfluidic devices, fans, pumps etc. Furthermore, depending on the dynamic viscosity of the fluid, vehicles considerably larger than MAVs can also operate in the low Reynolds number regime (e.g. flying vehicles with take-off mass of tens or hundreds of kilograms in the atmosphere of Mars).

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an aspect, the invention features a free-streamline airfoil including a front portion, the front portion including a leading edge geometry configured to force a sudden separation of the flow, and a contoured rear portion.

In another aspect, the invention features a free-streamline wing including a flat and/or contoured front portion upper surface and lower surface, a flat and/or contoured rear portion upper surface and lower surface, and a flow control device.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is an exemplary free-streamline (“FS”) airfoil with the front portion and rear portion.

FIG. 2 is an exemplary free-streamline (“FS”) airfoil with the rear portion being separate from the front portion.

FIG. 3 shows leading edge geometries for the front portion.

FIG. 4 is a side view of an exemplary free-streamline (“FS”) wing.

FIGS. 5, 6, 7, 8, 9 and 10 are exemplary graphs.

FIGS. 11, 12 and 13 illustrate the wing of the present invention compared to existing technologies.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

Airfoils operating in the low Reynolds number regime find application in wings and propellers of Miniature and Nano Air Vehicles (MAVs and NAVs), microfluidic devices, small radial and axial fans, and so forth.

The low Reynolds (Re) number regime can be defined as Re<50,000, where Re=U c/v, U is the flow speed, c, the airfoil/wing chord and v the kinematic viscosity of the fluid. In this low- Re regime, airfoils face two major problems: poor performance (low lift-to-drag ratio) and high sensitivity to external turbulence. Both problems are due to the formation of a laminar separation bubble that can only close if the separated flow transitions to turbulent. Whether the separated flow forms a closed bubble and the bubble extension relative to the airfoil chord determine the magnitude of performance degradation induced by the bubble presence.

Poor aerodynamic performance is characteristic of small fans for air circulation or cooling of electronic components and result in degraded flow rate per input power.

Miniature and Nano Air Vehicles (MAVs and NAVs) fly in a low Reynolds regime, Re<50,000 and face two major problems: short flight duration and poor controllability due to high sensitivity to atmospheric turbulence. Short flight duration stems from poor airfoil aerodynamic efficiency, which generally decreases with size. Small-scale fixed-wing aircraft are more sensitive to the sharp variations in atmospheric turbulence encountered in proximity to obstacles like buildings or trees, and in windy conditions. Below a critical threshold of Re approximately 50000, the lift coefficient of conventional thick airfoils wings is highly sensitive to atmospheric turbulence which strongly influences the location and extent of flow separation and transition to turbulence over the wing. When the aircraft encounters turbulence fluctuations, sharp changes in the separation and transition characteristics result in sudden and extreme variations in lift forces which, in turn, induce sudden oscillations and rotations making the drone difficult to control and subject to failure. This sensitivity to atmospheric turbulence becomes a major limitation for outdoor operation of MAVs and NAVs where the oscillations are exasperated by the low mass and inertia of these small vehicles. Increasing both flight duration and resistance to turbulence is challenging in the low Reynolds regime because it requires substantially different wing designs. Aircraft designers can increase robustness to atmospheric turbulence in several ways.

All the solutions (e.g. low aspect ratio wings, flexible wings, thin airfoils) drive MAV design towards low aspect ratio wings (AR<4). However, because vehicle aerodynamic efficiency is directly proportional to wing aspect ratio, improving control or robustness to turbulence is at odds with improving aerodynamic efficiency, and designers can either achieve efficient flight with high aspect ratio wings and thick airfoils, or develop thin and flexible low aspect ratio wings to fly outdoors or in turbulent atmospheric conditions. Current designs cannot achieve both flight characteristics simultaneously.

A challenge of accommodating flight endurance and resistance to turbulence is mastered in nature by insects, small birds and bats. Small natural flyers overcome this challenge by forcing flow separation over very thin wings using sharp leading edges, rough, corrugated airfoils and unsteady lift generation with wing flapping. Insect wings force flow separation at the leading edge in stark contrast to both larger flyers (e.g., birds) and fixed wing drones that are designed to operate with attached flows. Soon after separation, the flow over an insect wing transitions from laminar to turbulent and reattaches to the wing surface, improving aerodynamic performance and significantly reducing lift sensitivity to external turbulence.

The present invention draws inspiration by the flow separation found in small flyers. More specifically, the present invention integrates into high aspect ratio wings (AR>4) a relatively thick airfoil geometry (8% thickness compared to <3% for the best performing airfoils in the low Reynolds regime) that forces flow separation at the leading edge in order to achieve consistent and robust performance over a wide range of turbulence conditions without sacrificing aerodynamic efficiency. In addition, one possible design of the separated flow airfoil geometry can be composed of flat plates, eliminating the necessity for a carefully contoured airfoil shape and simplifying wing manufacturing. Subsystems, such as batteries, antennas and solar cells, can be easily integrated into the wing surface, reducing the required structural mass and potentially eliminating a need for a fuselage. If desired, the free-streamline airfoil can also have a contoured geometry for superior aerodynamic efficiency.

As shown in FIG. 1, an exemplary free-streamline (“FS”) airfoil 10 includes two functional elements, a front portion and a rear portion. The leading edge of the front portion, A, forces a sudden separation of the flow. The separated flow is characterized by an unstable shear layer which completes the transition to turbulence within a short fraction of the airfoil chord, c (this distance is a function of the Reynolds number). The rounded surface that defines the leading edge of the rear portion, B, has the function to facilitate the reattachment of the flow and to close the separation bubble maximizing the generation of lift. While in conventional airfoils. the location of the laminar turbulent transition is strongly influenced by the level of atmospheric turbulence, on the airfoil 10, the separation point is clearly defined at the leading edge of the front portion, A, and the transition to turbulence is consistently achieved before the flow reaches the rear portion. As a result, the lift and drag generated by the airfoil 10 is almost insensitive to external turbulence. A flow control device can operate at the leading edge of the front portion, A, and/or on rear section, B, or on the rear portion upper surface D. In FIG. 1, c=airfoil chord, k_{f}=length of the second part of the rear portion, k=length of the first part of the rear portion, τ=angle of the first part of the rear portion, τ_{f}=angle of the second part of the rear portion.

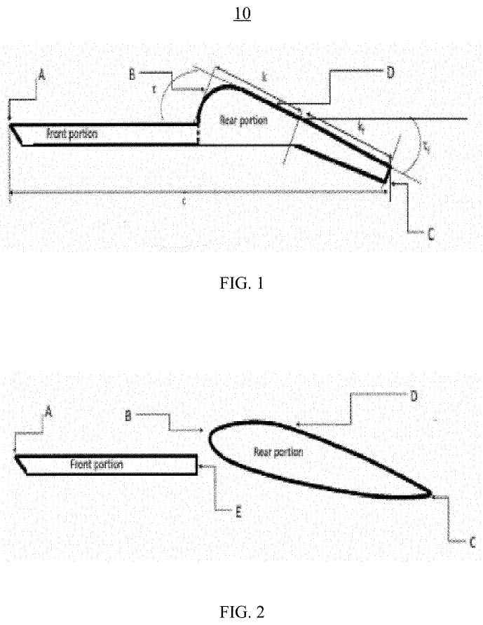

FIG. 2 shows a version of the free-streamline airfoil with the rear portion separated from the front portion and located at an arbitrary position behind the trailing edge of the front portion.

In summary, the exemplary airfoil 10 includes (1) a front portion with a lower surface which can be flat or it can be contoured and (2) an upper surface which can be flat or it can be contoured. The airfoil 10 includes (3) a rear portion with a lower surface and (4) an upper surface. The front portion upper surface can be of the same or a different length of the lower surface. The upper surface can be at an angle with the lower surface and also be flat or curved. When the rear and front portion are attached—the front portion upper and lower surfaces meet with the rear portion upper and lower surfaces. The flap of the rear portion protrudes back from the trailing edge of the rear portion and can be at an angle different from the first part of the rear portion. When the rear and front portions are distinct elements, the upper and lower surface of the front portion meet at the front portion trailing edge E. The flow separates at the leading edge of the front portion, A, and forms a free streamline which then impinges upon and re-attaches at the leading edge of the rear portion, B.

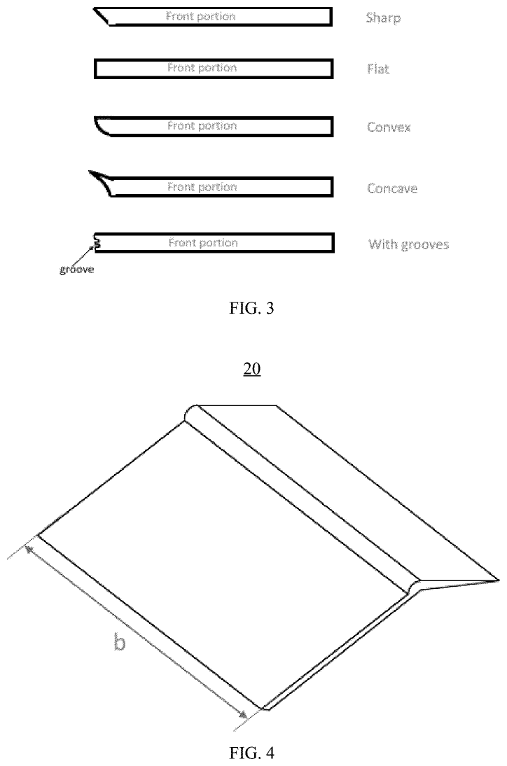

FIG. 3 shows examples of the front portion leading edge geometries for the free-streamline (“FS”) airfoil 10. A sharp, flat, rounded convex or rounded concave leading edge can be used to create flow separation. The front portion of the airfoil can also have a fully rounded shape. At the lowest Reynolds numbers, the flow separating from the leading may not have a sufficiently high Re number for transition if using a solid surface leading edge. Groves (cavities) can be present on the leading edge surface to increase (e.g. almost double) the boundary layer thickness.

FIG. 4 shows an exemplary application of the free-streamline airfoil in a free-streamline wing 20 for a fixed wing drone (not shown). b is the wing span-wise extension. The free-streamline airfoil can be used in a similar arrangement to create a propeller.

An optional flow control device located at the leading edge of the front portion and/or at the leading edge of the rear portion and/or on the upper surface of the rear portion can be used to increase the aerodynamic performance (i.e., lift, efficiency and/or power factor) of the above geometry. The flow control device, for example, can be a steady source of control such as a rotating cylinder or a continuous jet, a continuous jet with an unsteady velocity component, an unsteady excitation provided by other flow control devices, such as a zero-net-mass-flux (“synthetic”) jet or a Dielectric Barrier Plasma Actuator (DBPA), propellers integrated in the wing leading edge and/or trailing edge in the case of a vehicle, unsteady jets, combinations of steady and unsteady, and so forth. One effect of the flow control device is to increase the airfoil lift coefficient and/or, depending on the angle of attack, to reduce the drag coefficient.

Compared with conventional wings (with or without flow control), the wing 20 has several attractive features. For example, The wing 20 can generate high lift coefficients, which is advantageous for many aerodynamic applications. At small Reynolds number (<50000) and even in the absence of flow control, aerodynamic performance is significantly superior to existing airfoils. The use of flow control improves aerodynamic performance. This enables its application to small scale flying vehicles (e.g., take off mass <200 pounds), air vehicles for package delivery, reconnaissance, observation, and so forth. This enables the geometry to be used as the blade of a propeller.

The wing 20 enables the structure of a propeller to be built out of electric batteries or supercapacitor (e.g., ultracapacitor) elements. Such a propeller can be part of a rotary wing vehicle for Vertical Take Off and Landing (VTOL). A rotating part of the electric motor would be directly connected with the batteries providing power for its coils. Solar panels can also be embedded in the propeller to charge the batteries. A stator would be attached to the main frame of the VTOL vehicle.

A surface of the wing 20 can be made from functional system components (e.g., solar cells or batteries). This enables the use of subsystems as main structural elements of the wing. Electric batteries can constitute the wing itself with a several fold increase in range and endurance of a flying system compared to current existing solutions. Moreover, especially for nano and micro scale air vehicles, the distribution of subsystems and their mechanical load on the wing 20 enables higher wing aspect ratios. Since, differently from conventional wings, the wing performs aerodynamically well at small scales, a small wing chord (resulting from the high aspect ratio) still results in increased aerodynamic performance. This also enables the possibility of easy wing folding. Additionally, it makes it easier and potentially less expensive to integrate payload (e.g., an antenna) into the wing surface. These thin solid structures result in operative manufacturing costs significantly lower than conventional wings. Reduced capital expenses are also associated with the simpler manufacturing process.

Depending on the geometry, a volume enclosed by the wing's 20 structure can be large (the airfoil 10 is thick, e.g., 8%, compared to high performance airfoils for low Re number applications, e.g., 3%). This enables a large payload to be carried by the airfoil 10 and for easy payload integration.

The free streamline means that the upper surface of the airfoil 10 is open to the surrounding fluid, allowing for optical access, environmental sampling, radio communications, and so forth.

The wing 20 has several advantages. For example, the rear portion of the wing can have a flap (the second part of the rear portion) which noticeably increases aerodynamic performance and control. Moreover, the rear portion can be separated from the front portion creating a multi-element airfoil. Even at Reynolds numbers as low as a few thousand, the upper surface of the second airfoil (the rear portion) operates with a turbulent flow and allows an increase in airfoil efficiency and more reliable lift production when compared to prior FS wings.

Flow control can be introduced when high lift levels or superior aerodynamic efficiency (e.g. lift to drag ratio) are required. It is self-contained and does not necessarily require a seperate air supply. Self-contained actuation methods can be provided by one of many different flow control actuators including, for example, synthetic jets, a plasma actuators, and so forth which do not require additional steady or pulsed sources of air, simplifying the wing 20 design and construction. Integrated sensing of the flow reattachment and/or the wing 20 dynamics can be used to control the flow control device in order to maintain the desired aerodynamic performance of the wing. In FIG. 3, two exemplary graphs illustrate the impact of the flow control effort (CO on the coefficient of drag, CD (with CL increase) while in FIG. 4, exemplary graphs illustrate the effect of the wing geometry, k, on the lift coefficient, CL, vs. the angle of attack (no flow control).

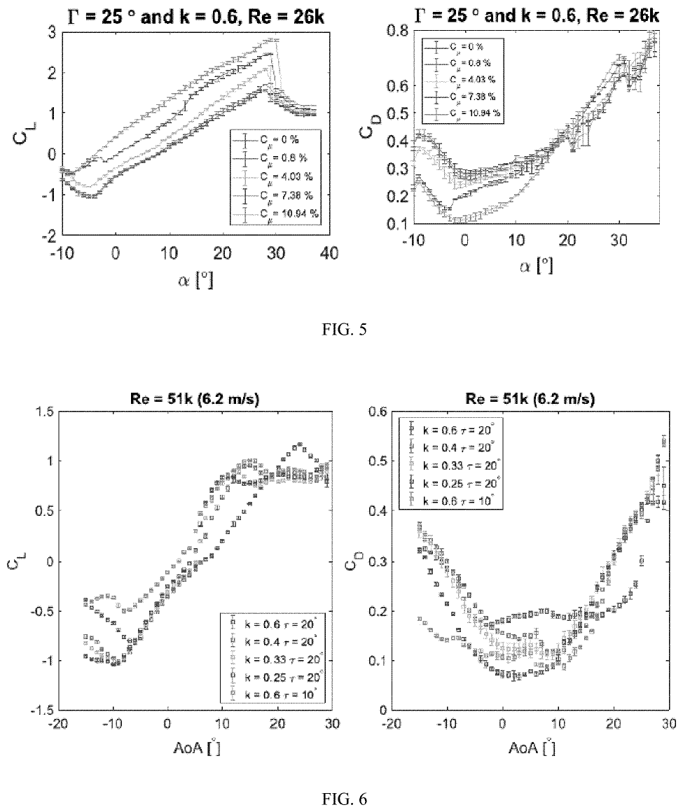

In FIG. 5, two exemplary graphs illustrate the effect of steady blowing.

FIG. 6 shows two exemplary graphs that illustrate the effect of a back protruding flap on the rearch section (no flow control).

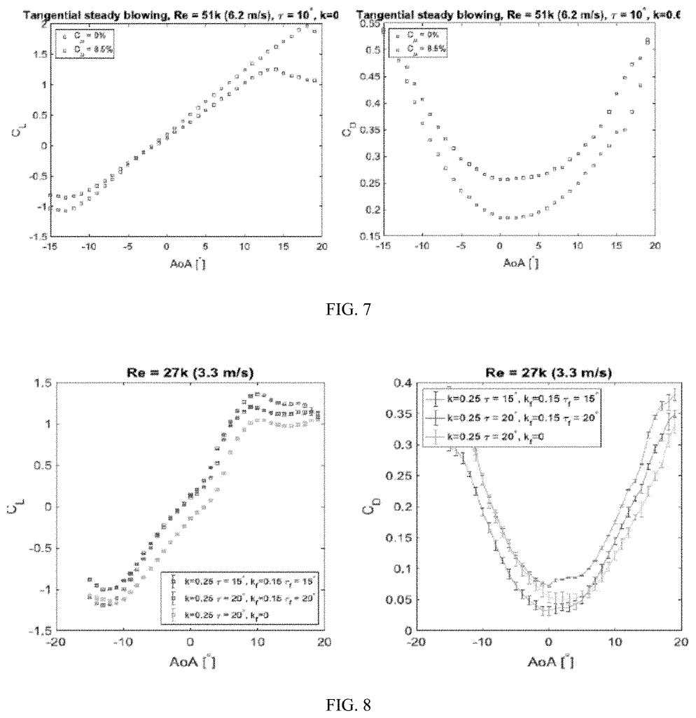

FIG. 7 shows two exemplary graphs that illustrate flow control with back flap (steady blowing).

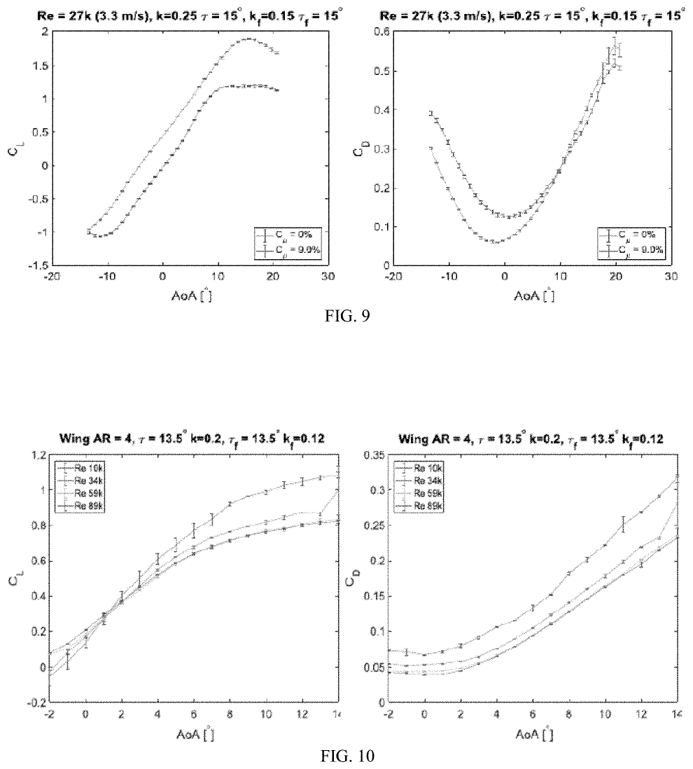

FIGS. 8, 9 and 10 show exemplary graphs illustrating lift, CL and drag, CD vs. angle of attack for a wide range of Reynolds number, Re.

The wind tunnel testing data shows converging maximum lift coefficients with increasing Reynolds number (toward Re=89,000). The wind tunnel testing data shows reducing minimum drag coefficients with increasing Reynolds number (toward Re=89,000). Thus, improved aerodynamic performance at increasing Reynolds number is presumed. Therefore, the wing aerodynamics performance should improve for larger scale applications (Re>100000).

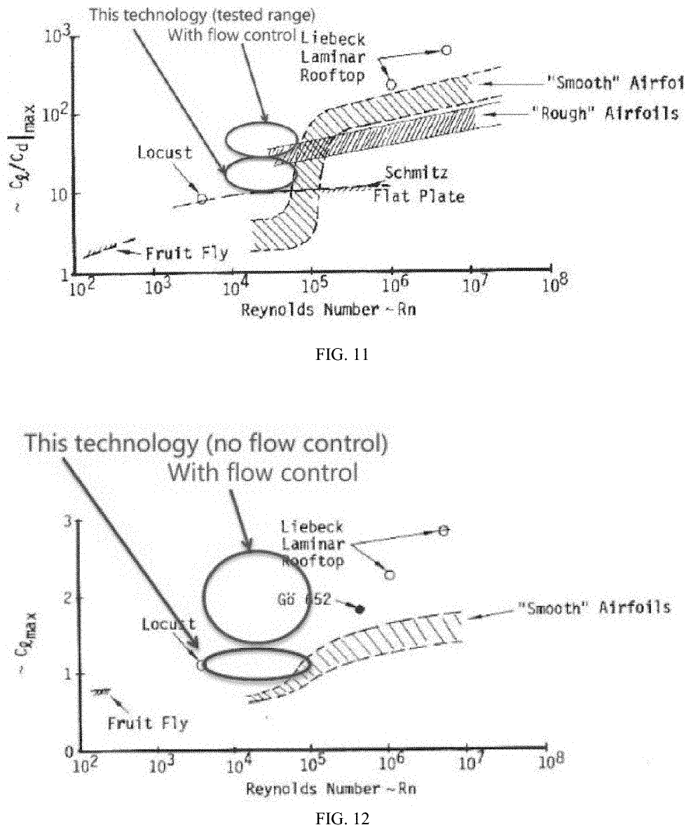

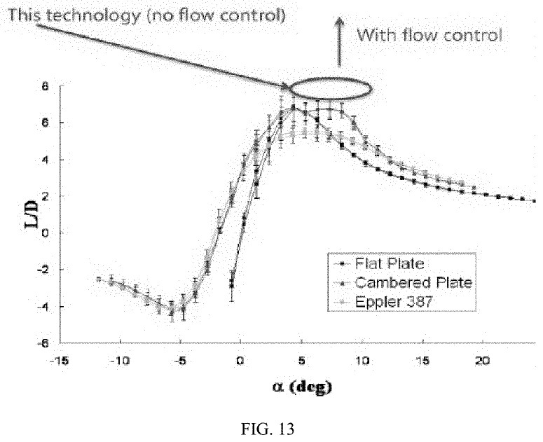

FIGS. 11, 12 and 13 illustrate the performance of airfoil 10 of the present invention compared to existing technologies.

Therefore high wing aspect ratio (AR) is an important lever to optimize aerodynamic efficiency.

At low Re, very thin airfoils (less than 3% thickness based on chord) are the second best performing compared to the wing of the present invention. Thick conventional airfoils come third.

First, aspect ratio is extremely limited when using thin surfaces because of the required structural stiffness. The low Aspect Ratio limits the aerodynamic efficiency.

Second, different from thin plates, the wing of the present invention is thick enough and the geometry is simple enough to allow the wing to be constructed using functional elements. This allows two things: mass savings compared to a conventional wing structure and a great reduction in concentrated structural loads further reducing structural requirements and therefore structural support mass. This allows fuel/energy mass fractions close to 90% of the total take off mass (mission dependent), compared to fuel/energy mass fractions of 30-40% for conventional drones.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A free-streamline airfoil comprising:
a front portion, the front portion that including a leading edge geometry configured to force a sudden separation of the flow; and
a contoured rear portion.

2. The free-streamline airfoil of claim 1 wherein the front portion and the contoured rear portion form a building block of a wing or a propeller, a three-dimensional geometry obtained by stacking along a span-wise direction.

3. The free-streamline airfoil of claim 1 wherein a flow separating from a leading edge of the front portion comprises an unstable shear layer that transitions to a turbulent flow.

4. The free-streamline airfoil of claim 1 wherein the contoured rear portion is configured to facilitate a reattachment of flow on its surface and to close a separation bubble to improve a generation of lift and reducing an airfoil drag.

5. The free-streamline airfoil of claim 1 wherein the leading edge of the front portion is sharp.

6. The free-streamline airfoil of claim 1 wherein the leading edge of the front portion is flat.

7. The free-streamline airfoil of claim 1 wherein the leading edge of the front portion is rounded with a convex shape.

8. The free-streamline airfoil of claim 1 wherein the leading edge of the front portion is rounded with a concave shape.

9. The free-streamline airfoil of claim 1 wherein the leading edge of the front portion has sharp, flat or rounded shape with groves on its surface.

10. The free-streamline airfoil of claim 1 wherein the front portion of the airfoil comprises a lower surface and an upper surface.

11. The free-streamline airfoil of claim 10 wherein the upper surface and/or the lower surface of the front portion is flat.

12. The free-streamline wing of claim 11 wherein the upper surface is at an angle from the lower surface.

13. The free-streamline airfoil of claim 10 wherein the upper surface and/or the lower surface of the front portion is contoured.

14. The free-streamline wing of claim 10 wherein the upper surface and lower surface of the front portion are of equal lengths.

15. The free-streamline wing of claim 10 wherein the upper surface and lower surface of the front portion are of unequal lengths.

16. The free-streamline wing of claim 1 wherein the rear portion is connected to the front portion, an upper surface and a lower surface of the front portion merged with an upper surface and a lower surface of the rear portion.

17. The free-streamline wing of claim 16 wherein the rear portion of the airfoil has a contoured leading edge to facilitate reattachment of separated flow.

18. The free-streamline wing of claim 16 wherein the rear portion of the airfoil comprises a lower surface and an upper surface.

19. The free-streamline wing of claim 18 wherein the lower surface and/or upper surface of the rear portion is flat.

20. The free-streamline wing of claim 18 wherein the lower surface and/or upper surface of the rear portion is contoured.

21. The free-streamline wing of claim 1 wherein the rear portion of the airfoil is separated from the front portion by an arbitrary distance and constitutes a single airfoil, a front portion upper surface ending at a front portion lower surface.

22. The free-streamline wing of claim 21 wherein the lower surface and/or upper surface of the rear portion is flat.

23. The free-streamline wing of claim 21 wherein the lower surface and/or upper surface of the rear portion is contoured.

24. A free-streamline wing comprising:
a flat and/or contoured front portion upper surface and lower surface;
a flat and/or contoured rear portion upper surface and lower surface; and
a flow control device.

25. The free-streamline wing of claim 24 wherein the flow control device is located at a front portion leading edge in a region where flow separates from the surface.

26. The free-streamline wing of claim 24 wherein the flow control device is located at the rear portion leading edge in the region where the flow impinges/reattaches on the surface.

27. The free-streamline wing of claim 24 wherein the flow control device is located at the rear portion upper surface in the region where the flow can separate from the surface.

28. The free-streamline wing of claim 24 wherein the flow control device is a steady source.

29. The free-streamline wing of claim 24 wherein the flow control device is an unsteady excitation provided by a zero-net-mass-flux jet.

30. The free-streamline wing of claim 24 wherein the flow control device is an unsteady excitation provided by a Dielectric Barrier Plasma Actuator (DBPA).

31. The free-streamline wing of claim 24 wherein the flow control device is a propeller integrated at the front/rear portion leading/trailing edge.
